(19) United States
(12) Patent Application Publication
(10) Pub. No.: US 2026/0237090 A1
(43) Pub. Date: Aug. 13, 2026

(54) EDGE NODE OBJECT DETECTION

(71) Applicant: CAREGILITY CORPORATION, WALL TOWNSHIP, NJ (US)

(72) Inventors: Raja Kedar GANTA, Bothell, WA (US); Hai Xuan NGUYEN, Bradenton, FL (US); Bhupesh SOOD, East Brunswick, NJ (US); Rajiv BHATIA, Marlboro, NJ (US); Anup FRANCIS, Suwanee, GA (US)

(21) Appl. No.: 19/531,926

(22) Filed: Feb. 6, 2026

Related U.S. Application Data
(60) Provisional application No. 63/755,406, filed on Feb. 7, 2025.

(51) Int. Cl. G06T 7/70; G06T 7/13

(52) U.S. Cl. CPC G06T 7/70; G06T 7/13

(57) ABSTRACT

According to one aspect, edge node object detection may include receiving an execution dataset. The execution dataset may include a set of sensor data associated with activity of an individual from an execution phase. The computer-implemented method for edge node object detection may include passing the execution dataset through an edge node object detection model to generate an edge node object detection. The edge node object detection model may draw inferences based on an input dataset. The input dataset may include a set of sensor data associated with activity of an individual by drawing an inference of movements based on a rule set. The sensor data may include image capture data. The edge node object detection may include a pose estimate. The pose estimate may be one of standing, sitting, or lying.

### CROSS-REFERENCE TO RELATED APPLICATIONS

This application claims the benefit of U.S. Provisional Patent Application, Serial No. 63/755406 (Attorney Docket No. CAR-56779) entitled “EDGE NODE ACTIVITY DETECTION”, filed on February 7, 2025; the entirety of the above-noted application(s) is incorporated by reference herein.

### BACKGROUND

Falls are a major concern for older adults and for those that love and care for them. They are a leading cause of injury for adults older than 65, according to the U.S. Centers for Disease Control and Prevention. More than a third of those who fell reported needing medical treatment or being benched from activity for at least a day. Falls are particularly dangerous for the elderly due to their high frequency and severe consequences. The dangers of falling for older adults include serious injuries like hip and hand fractures, head trauma and even death. The combined effects of loss of muscle, bone density, flexibility, and sensory and cognitive function pose a significant threat of falling for older adults. Specifically, the loss of balance due to a trip or slip can often be recovered by quick corrective actions that require fast and powerful muscle responses. However, weaker muscles make it harder to stay balanced and to perform these corrective actions in a timely manner.

Today, nurses are burdened with the demand to manage a wide range of routine tasks while taking care of the patients. For example, these routine tasks include administering medication, helping patients with mobility, detecting early signs of deterioration, and continuous monitoring of vital signs. In addition to these core responsibilities, nurses are tasked with identifying risks such as falls, the development of bed sores, and ensuring that patients are engaging in necessary exercises to improve recovery and maintain health. The constant pressure of performing these duties causes burnout, and reduce overall care quality.

Existing systems rely heavily on manual observation and documentation, which can be time-consuming and error prone. Nurses manually track patient movements, activity levels, and risks such as falls or bed sores, which often leads to gaps in real-time patient care. In particular, bed sore and fall risks are sometimes identified too late so requires continuous monitoring. The inability to effectively monitor patient movement and activity patterns contributes to the growing problem of bed sores and falls, both of which pose serious health risks and lead to longer recovery times.

### BRIEF DESCRIPTION

According to one aspect, a system for edge node object detection may include a memory and a processor. The memory may store one or more instructions. The processor may execute one or more of the instructions stored on the memory to perform one or more acts, actions, and/or steps. The processor may perform receiving an execution dataset. The execution dataset may include a set of sensor data associated with activity of an individual from an execution phase. The processor may perform passing the execution dataset through an edge node object detection model to generate an edge node object detection. The edge node object detection model may draw inferences based on an input dataset. The input dataset may include a set of sensor data associated with activity of an individual by drawing an inference of movements based on a rule set.

The sensor data may include image capture data. The edge node object detection may include a pose estimate. The pose estimate may be one of standing, sitting, or lying. The edge node object detection may include an incomplete pose estimate. The processor suggests alternative sensor positioning based on the incomplete pose estimate. The passing the execution dataset through the edge node object detection model to infer the edge node object detection may include utilizing a debouncing algorithm. The passing the execution dataset through the edge node object detection model to infer the edge node object detection may include utilizing noise filtering. The edge node object detection model may include a vision artificial intelligence (AI) model.

According to one aspect, a computer-implemented method for edge node object detection may include receiving an execution dataset. The execution dataset may include a set of sensor data associated with activity of an individual from an execution phase. The computer-implemented method for edge node object detection may include passing the execution dataset through an edge node object detection model to generate an edge node object detection. The edge node object detection model may draw inferences based on an input dataset. The input dataset may include a set of sensor data associated with activity of an individual by drawing an inference of movements based on a rule set.

The sensor data may include image capture data. The edge node object detection may include a pose estimate. The pose estimate may be one of standing, sitting, or lying.

According to one aspect, a system for edge node object detection may include a memory, a processor, and a display. The memory may store one or more instructions. The processor may execute one or more of the instructions stored on the memory to perform one or more acts, actions, and/or steps. The processor may perform receiving an execution dataset. The execution dataset may include a set of sensor data associated with activity of an individual from an execution phase. The processor may perform passing the execution dataset through an edge node object detection model to generate an edge node object detection. The edge node object detection model may draw inferences based on an input dataset. The input dataset may include a set of sensor data associated with activity of an individual by drawing an inference of movements based on a rule set. The display may render a notification based on the edge node object detection.

The sensor data may include image capture data. The edge node object detection may include a pose estimate. The pose estimate may be one of standing, sitting, or lying.

### BRIEF DESCRIPTION OF THE DRAWINGS

FIG. 1 is an exemplary component diagram of a system for edge node object detection, according to one aspect.

FIG. 2 is an exemplary component diagram of a system for edge node object detection, according to one aspect.

FIG. 3 is an exemplary flow diagram of a computer-implemented method for edge node object detection, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

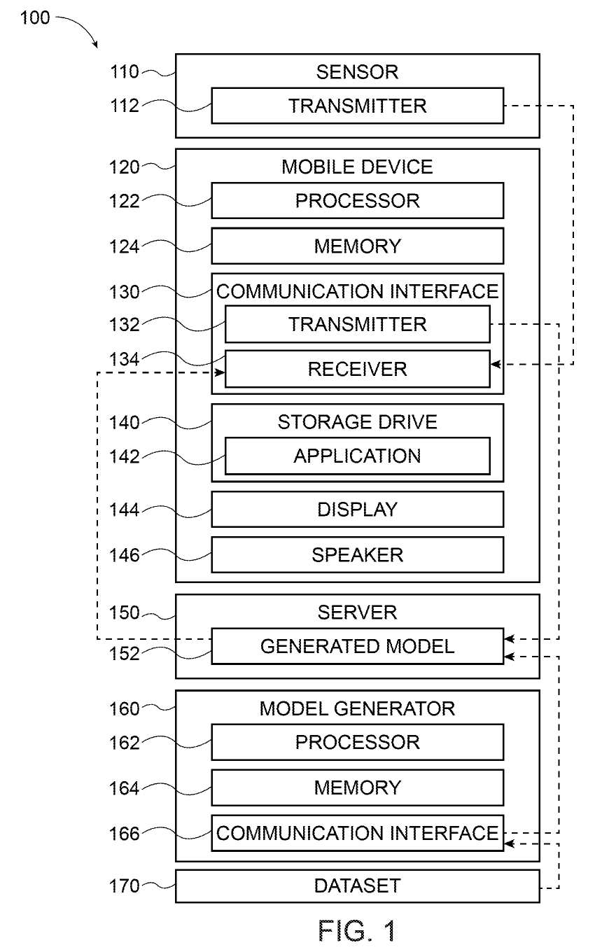

FIG. 1 is an exemplary component diagram of a system for edge node object detection, according to one aspect. In this regard, it will be appreciated that different portions or configurations of the system 100 of FIG. 1 may be utilized as a system for training an edge node object detection model as well as a system for edge node object detection which utilizes the edge node object detection model.

As a brief introduction to one or more components of the system 100 of FIG. 1, the system 100 may include one or more sensors 110 including a transmitter 112, a controller 120 including a processor 122, a memory 124, a communication interface 130 having a transmitter 132 and a receiver 134, a storage drive 140 for storing an application 142 or edge node object detection application to be executed, a display 144, and a speaker 146. The system 100 may include a server 150 which may house or store the edge node object detection model 152, which may be generated by a model generator 160 including a processor 162, a memory 164, and a communication interface 166 based on an input dataset 170. The communication interface 166 may be equipped for user interaction. For example, the communication interface 166 may include a touchscreen and/or a terminal. It will be appreciated that components within the controller 120 or within the model generator 160 may be communicatively coupled via one or more busses and in computer communication with one another. Similarly, components of the system 100 of FIG. 1 may be communicatively coupled via a network and/or wireless communication and be in computer communication with one another, for example. Further, acts, actions, and/or steps performed by any of the processors described herein may be achieved via distributed processing and/or implemented via mobile devices, for example.

The memory 124 may store one or more instructions. The processor 122 may execute one or more of the instructions stored on the memory 124 to perform one or more acts, actions, and/or steps.

The sensors 110 may include an image capture device or one or more camera modules capturing image capture data of a patient or an individual. The image capture data may be captured using an image capture device or an image capture sensor. Additionally, the image capture data may be down sampled and feature vectors may be generated. For the image detection, from the video frame, the object may be identified and key points may be measured for the identified object, such as the patient, for example. If the patient is not fully detected, the processor 122 may cause an alert to be rendered on the display 144 or alert the staff via the speaker 146, for example.

Additionally, the image detection may detect one or more objects in the room, such as whether or not the patient is utilizing any devices to assist movement, such as a cane, for example. According to one aspect, the processor 122 may utilize the edge node object detection model 152 to provide pose estimation for a patient detected from the image capture device or image capture data using skeletal key points of the patient. These key points may be fed through a translation engine by the processor 122 to identify movement transitions. The translation engine may classify movements associated with the patient, such as standing, sitting, laying down, immobility, bed exits, etc. and whether or not the patient is undergoing movement transition.

The processor 122 may include a graphical processing unit (GPU) and/or a neural processing unit (NPU) to facilitate computer vision processing. The processor 122 may generate pose estimates (e.g., standing, sitting, lying in bed) and associated confidence levels based on the image capture data or otherwise detect human activity in a room. If the confidence score associated with the pose estimate is below a threshold confidence, the system may wait for additional sensor data to generate an updated pose estimate or may pivot to a different set of sensors based on the confidence.

Additionally, the processor 122 may generate estimates for a patient’s pose when portions of the patient’s body are hidden or occluded from view of the image capture device. If the patient pose is not readily detectable or is an incomplete pose estimate, the processor 122 may suggest strategic or alternative camera positioning to ensure that the entire patient is visible, thereby improving the reliability of activity monitoring and minimizing detection errors. According to one aspect, infrared image capture devices or sensors may be utilized, thereby enabling functional optimally continuous monitoring under various lighting conditions, including low light conditions at nighttime. Further, the processor 122 may analyze a gait and speed associated with patient movement.

Additionally, the processor 122 may interface with the image capture sensors to generate a determined camera orientation for the image capture device. For example, it may be determined that an image capture device is left-facing, right-facing, or center-facing relative to the patient, leading to more precise activity tracking and a better understanding of the patient's movements. Motion blurring may be addressed using temporal filtering to smooth transitions between frames, reducing the impact of motion blur and enhancing the clarity of object detection.

According to one aspect, the sensors 110 may include sensors installed on a bed where the patient is located. For example, the sensors 110 may include pressure sensors, tactile sensors, etc.

The edge node object detection model 152, may take as input, any of the determinations based on the sensor data from the sensors 110, such as the pose estimates, camera orientation, location, positioning of the patient, gait, movement information, etc. The edge node object detection model 152 may enable nurses to have advanced, real-time monitoring and data analysis capabilities. For example, the sensors 110 and the processor 122 may track patient movement and recognize location. According to one aspect, a tracking box around the patient’s body may be utilized to track the patient and keep the system focused on tracking that particular patient. The processor 122 may perform receiving an execution dataset. In this way, the processor 122 may receive an execution dataset and the execution dataset may include a set of sensor data associated with activity of an individual from the execution phase of the edge node object detection. The edge node object detection model may draw inferences based on an input dataset (e.g., spatial orientation from input dataset). The input dataset may include a set of sensor data associated with activity of an individual from the specialized ruleset applied to features of the input dataset.

The processor 122 may perform passing the execution dataset through an edge node object detection model to generate an edge node object detection. For example, a tracking box around the patient may be utilized by the processor 122 and the edge node object detection model 152 to infer the edge node object detection. The edge node object detection may be a prediction of whether the patient is at risk of falling, for example. The sensors 110 and the processor 122 may monitor patient mobility in real-time, including walking, getting up, or moving around. This helps identify patterns of inactivity or abnormal movement that may indicate risks of falls or the need for more physical activity. Additionally, the sensors 110 and the processor 122 may assess changes in states, such as emotional states and discomfort, alerting caregivers to potential distress based on visual cues. This computer vision approach is designed to be modular, scalable, and adaptable. This ensures that healthcare facilities may stay at the forefront of technology, continuously improving patient care and operational efficiency.

The edge node object detection model 152, once generated, may be configured to encourage exercise by tracking patient activity levels. For example, a system for edge node object detection may encourage physical activity and exercise, to promote recovery and maintain health. Additionally, the system for edge node object detection may continuously observe patient position and activity, sending alerts when patients have been immobile for too long. This ensures early intervention to prevent pressure ulcers or bed sores. The system for edge node object detection may detect signs of unsteady movement or abnormal walking patterns, providing early warnings of fall risks and enabling caregivers to intervene before accidents occur.

Thereafter, an internal state engine of the edge node object detection model 152 may detect the movement sequence of the patient and identify potentially unsafe transitions. The internal state engine may make inferences regarding the state of the patient based on contextual information around the patient, the patient’s previous state, the patient’s location, and correlation between different sensors of the sensors 110.

According to one aspect, the edge node object detection model 152 may include an internal rules engine which may run through configurable thresholds to identify the movements and identify an immobility risk for bed sores for the patient. Further, the internal rules engine of the edge node object detection model 152 may generate a confidence level while applying context, such as visitors in the room (e.g., other occupants), patient leaving the room (e.g., movement of the patient), the duration of the patient movement (e.g., how long has the patient been on the bed or the pose of the patient on the bed), etc.

In this way, artificial intelligence (AI) and computer vision may be utilized to augment real time monitoring of patient activity to prevent or mitigate bed sores, assess fall risks, while continuously improving patient care and operational efficiency. The utilization of the edge node object detection model 152 may provide the advantage or benefit of reducing the burden on nurses by automating routine tasks of rounding on the patients while improving the overall care quality. According to one aspect, the sensors 110 may include infrared sensors detecting thermal and/or photonic sensor data.

Based on the input dataset including a set of image capture data associated with activity of the first individual, the edge node object detection model 152 may assess the risk level of falls associated with an individual during an execution phase. For example, based on detailed pose estimation data, the system may identify movements or postures that indicate a heightened fall risk, allowing nurses to take preventive measures before accidents occur. Additionally, the edge node object detection model 152 may adjust the fall risk based on changes in the environment, such as changing room conditions such as furniture rearrangements, lighting variations, and previous patient movements. The states and risk levels may be analyzed on the system and/or sent to the cloud-based applications as metadata for additional analysis to generate alerts for users take corrective actions. According to one aspect, cloud applications may categorize alerts and tasks into the right priority levels based on the metadata received to deliver them to a dashboard rendered on the display 144. Thus, the display 144 may render a notification based on the edge node object detection. Additionally, AI from cloud applications may perform device level audio playback as patient prompts.

Further, false positive and false negative mitigation may be implemented. For example, filtering and smoothing techniques may be implemented to reduce errors by smoothing out fluctuations in the data, leading to enhanced system reliability and precision. Additionally, a debouncing algorithm may manage false positives and false negatives, ensuring accurate detection and processing of state changes, such as when a patient's activity transitions between states (e.g., from sitting to standing or lying in bed). For example, predictions may be made regarding the patient state over a predetermined period of time or a time window to mitigate prediction flicker (e.g., swings in the AI prediction). Noise filtering may filter out noise or unintended fluctuations in signals, eliminating multiple unwanted state transitions and ensuring that the system only registers significant, intentional changes in patient activity. Further, time-based, or frame-based debouncing may be implemented to enhance accuracy by effectively filtering out noise and stabilizing transitions between frames. This ensures that the system does not get overwhelmed by rapid changes and may provide more reliable, consistent results.

The system also addresses complex challenges, such as differentiating between various types of sitting positions (e.g., sitting on a bed versus sitting on a chair). This fine-grained differentiation is key to understanding and monitoring patient activities more effectively. Thus, the system may generate a context awareness flag to make distinctions, thereby improving the accuracy of object detection and supporting better care decisions. For example, whether a patient is sitting on a bed or a chair may have different implications for patient care, and thus, the image capture device and the system may utilize the context of these different scenarios to facilitate the generation of the fall risk prediction. In this way, context awareness may improve the accuracy of object detection and supporting better care decisions.

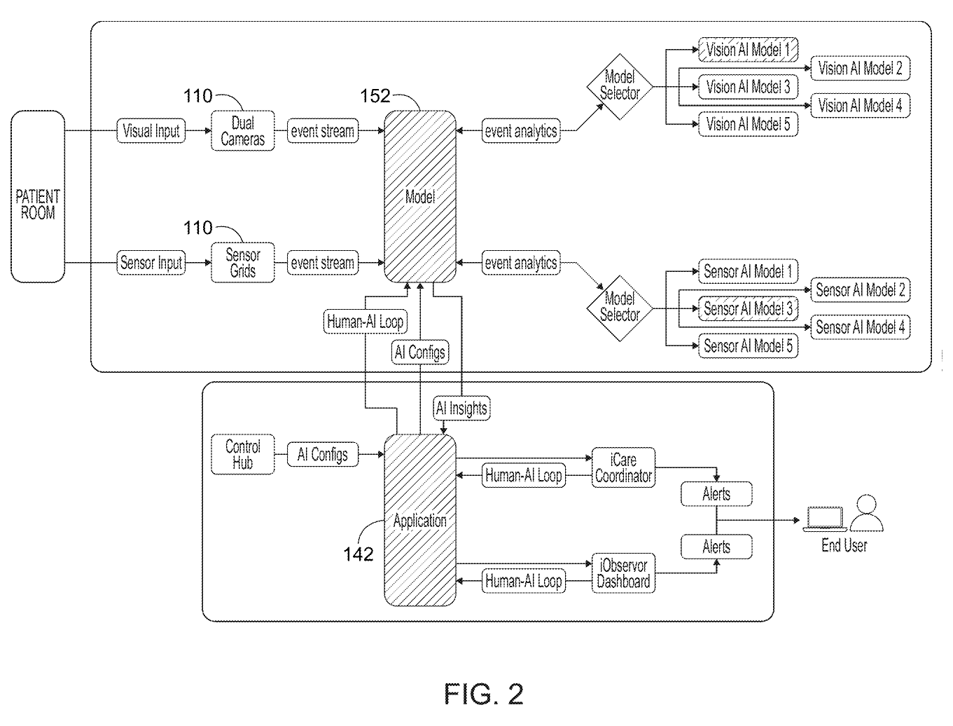

FIG. 2 is an exemplary component diagram of a system for edge node object detection, according to one aspect. The left side of the diagram represents the input sources located within the patient room and may include utilization of the sensors 110. For example, dual cameras may be implemented. An event stream may include raw sensor data which may be processed into feature vectors and skeletal key points by the processor 122. The system may utilize Android-based or Linux-based endpoints equipped with dual cameras (e.g., 5x and 40x), where AI processing primarily runs on the 5x camera feed providing a 120-140 degree field of view. Additionally, the system may integrate sensor data from external sensors, such as hospital bed sensors to correlate with visual data.

### Edge Node AI Processing Layer

The central portion of the diagram details the local processing that occurs on the "edge node" (e.g., which may utilize GPU/NPU acceleration) to ensure privacy by not sending raw audio or video outside the room. The platform may be modular, utilizing "Vision AI Models" for tasks like human pose estimation and gait analysis, and "Sensor AI Models" for analyzing bed-related data. Any of the models discussed herein may be included within the edge node object detection model 152. The system may utilize a model selector to allow the system to switch between native AI capabilities and specialized models from partners based on the specific healthcare needs (e.g., wound analysis over video to analyze the healing process). A Human-AI loop may reflect the system's ability to incorporate contextual rules and human-defined thresholds into its decision-making process. As data flows through the models of the edge node object detection model 152, it is transformed into actionable intelligence.

The translation engine may classify specific movements (e.g., standing, sitting, laying down, bed exits), while the internal state engine may detect sequences to identify unsafe transitions.

The output and interaction layer may enable the processed information to reach the end user via the display 144 or speaker 146. The processor 122 may categorize events into different priority levels (e.g., informational warnings vs. high-alert fall risks) and generate specific tasks for caregivers. According to one aspect, an end user and observer dashboard may be provided or rendered. The dashboard may present states and risk levels, sent as metadata to cloud-based applications, which may then populate the dashboard and be used by nurses to monitor patients in real-time. The system can also prompt the patient directly via device-level audio playback based on cloud-based intelligence. The platform layer may receive the metadata and prioritize or render alerts. Again, the observer dashboard may be a final interface where caregivers see the status and risk levels (e.g., bed sore risks or fall alerts). Further patient prompts may be provided via a return path where the cloud intelligence may trigger audio playback on the system to prompt the patient (e.g., “please stay in bed, a nurse is coming”) based on the edge node object detection model 152 and the sensor data.

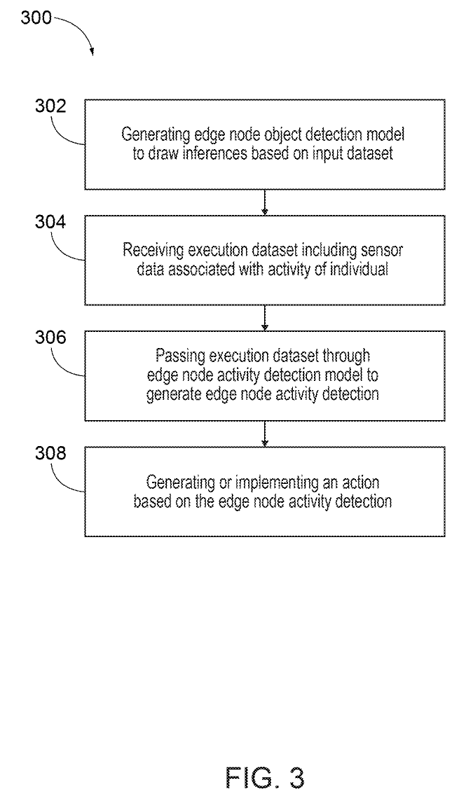

FIG. 3 is an exemplary flow diagram of a computer-implemented method 300 for edge node object detection, according to one aspect. The computer-implemented method 300 for edge node object detection may include generating 302 an edge node object detection model to draw inferences based on an input dataset. The input dataset may include a set of sensor data associated with activity of an individual by drawing an inference of movements based on a rule set. The computer-implemented method 300 for edge node object detection may include receiving 304 an execution dataset. The execution dataset may include a set of sensor data associated with activity of an individual from an execution phase. The computer-implemented method for edge node object detection may include passing 306 the execution dataset through an edge node object detection model to generate an edge node object detection. The computer-implemented method for edge node object detection may include generating 308 and/or implementing an action (e.g., via the processor, display, speaker, application, etc.) based on the edge node object detection (e.g., providing early warnings of fall risks and enabling caregivers to intervene, rendering a notification for either the caregiver or the patient via the display or the speaker, etc.).

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more "processors"), a "memory", a “storage drive”, a "bus", and one or more programmable input/output (I/O) peripherals.

A "database", as used herein, may refer to a table, a set of tables, and a set of data stores (e.g., disks) and/or methods for accessing and/or manipulating those data stores.

An "operable connection", or a connection by which entities are "operably connected", is one in which signals, physical communications, and/or logical communications may be sent and/or received. An operable connection may include a wireless interface, a physical interface, a data interface, and/or an electrical interface.

A "computer communication", as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

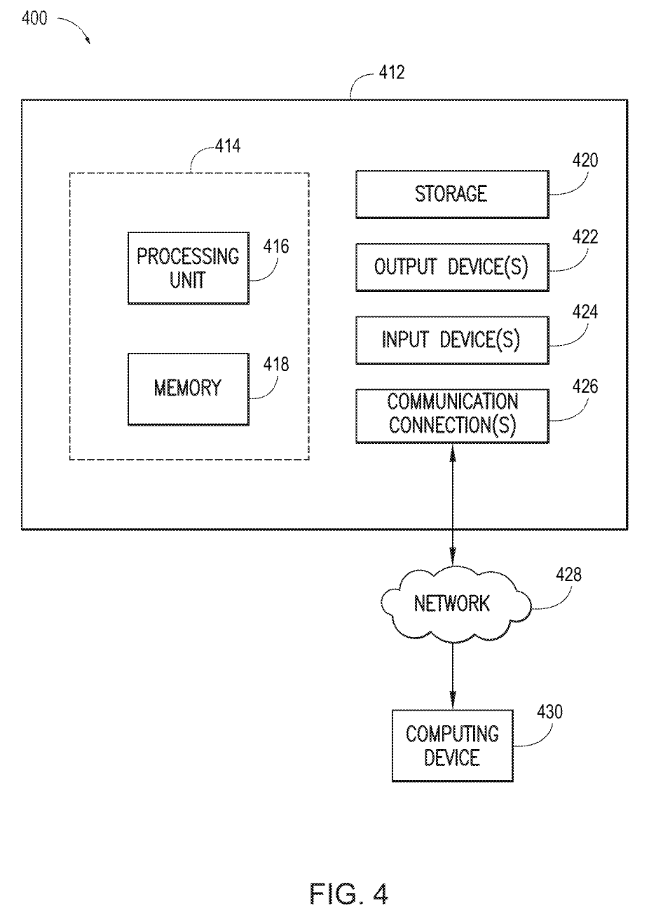

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

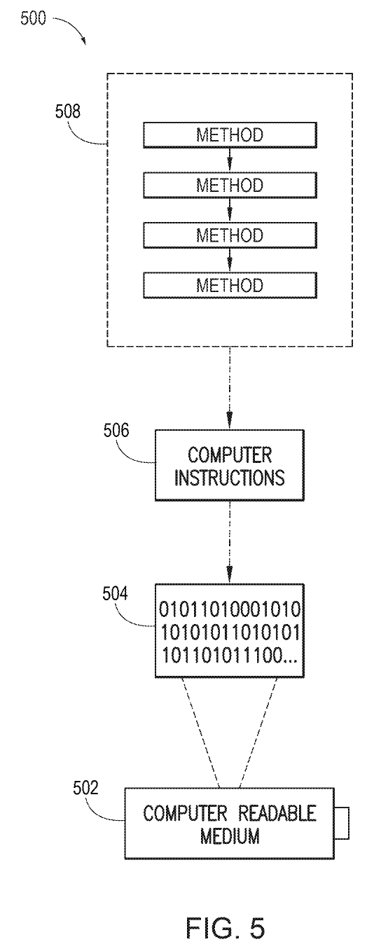

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero’s and one’s as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 300 for edge node object detection of FIG. 3. In another aspect, the processor-executable computer instructions 506 may be configured to implement a system, such as the system 100 for edge node object detection of FIGS. 1-2. Many such computer-readable media may be devised by those of ordinary skill in the art that are configured to operate in accordance with the techniques presented herein.

As used in this application, the terms "component”, "module," "system", "interface", and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term "article of manufacture" as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, "or" is intended to mean an inclusive "or" rather than an exclusive "or". Further, an inclusive “or” may include any combination thereof (e.g., A, B, or any combination thereof). In addition, "a" and "an" as used in this application are generally construed to mean "one or more" unless specified otherwise or clear from context to be directed to a singular form. Additionally, at least one of A and B and/or the like generally means A or B or both A and B. Further, to the extent that "includes", "having", "has", "with", or variants thereof are used in either the detailed description or the claims, such terms are intended to be inclusive in a manner similar to the term "comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for edge node object detection, comprising:
a memory storing one or more instructions; and
a processor executing one or more of the instructions stored on the memory to perform:
receiving an execution dataset, wherein the execution dataset includes a set of sensor data associated with activity of an individual from an execution phase; and
passing the execution dataset through an edge node object detection model to generate an edge node object detection,
wherein the edge node object detection model draws inferences for the edge node object detection based on a rule set, and
wherein the input dataset includes a set of sensor data associated with activity of an individual.

2. The system for edge node object detection of claim 1, wherein the sensor data is image capture data.

3. The system for edge node object detection of claim 1, wherein the edge node object detection includes a pose estimate.

4. The system for edge node object detection of claim 3, wherein the pose estimate is one of standing, sitting, or lying.

5. The system for edge node object detection of claim 1, wherein the edge node object detection includes an incomplete pose estimate.

6. The system for edge node object detection of claim 5, wherein the processor suggests alternative sensor positioning based on the incomplete pose estimate.

7. The system for edge node object detection of claim 1, wherein passing the execution dataset through the edge node object detection model to infer the edge node object detection includes utilizing a debouncing algorithm.

8. The system for edge node object detection of claim 1, wherein passing the execution dataset through the edge node object detection model to infer the edge node object detection includes utilizing noise filtering.

9. The system for edge node object detection of claim 1, wherein the edge node object detection model includes a vision artificial intelligence (AI) model.

10. A computer-implemented method for edge node object detection, comprising:
receiving an execution dataset, wherein the execution dataset includes a set of sensor data associated with activity of an individual from an execution phase; and
passing the execution dataset through an edge node object detection model to generate an edge node object detection,
wherein the edge node object detection model draws inferences for the edge node object detection based on a rule set, and
wherein the input dataset includes a set of sensor data associated with activity of an individual.

11. The computer-implemented method for edge node object detection of claim 10, wherein the sensor data is image capture data.

12. The computer-implemented method for edge node object detection of claim 10, wherein the edge node object detection includes a pose estimate.

13. The computer-implemented method for edge node object detection of claim 12, wherein the pose estimate is one of standing, sitting, or lying.

14. A system for edge node object detection, comprising:
a memory storing one or more instructions; and
a processor executing one or more of the instructions stored on the memory to perform:
receiving an execution dataset, wherein the execution dataset includes a set of sensor data associated with activity of an individual from an execution phase;
passing the execution dataset through an edge node object detection model to generate an edge node object detection,
wherein the edge node object detection model draws inferences for the edge node object detection based on a rule set, and
wherein the input dataset includes a set of sensor data associated with activity of an individual by drawing an inference of movements based on a rule set; and
a display rendering a notification based on the edge node object detection.

15. The system for edge node object detection of claim 14, wherein the sensor data is image capture data.

16. The system for edge node object detection of claim 14, wherein the edge node object detection includes a pose estimate.

17. The system for edge node object detection of claim 16, wherein the pose estimate is one of standing, sitting, or lying.
